(19) United States
(12) Patent Application Publication
(10) Pub. No.: US 2020/0238601 A1
(43) Pub. Date: Jul. 30, 2020

(54) 3D-PRINTED SHAPED PARTS MADE FROM MORE THAN ONE SILICONE MATERIAL

(71) Applicant: WACKER CHEMIE AG, Munich (DE)

(72) Inventors: Bernd PACHALY, Mehring (DE); Christian Georg BAUMANN, Simbach am Inn (DE); Vera SEITZ, Muehldorf (DE)

(73) Assignee: WACKER CHEMIE AG, Munich (DE)

(21) Appl. No.: 16/652,267

(22) PCT Filed: Sep. 29, 2017
(86) PCT No.: PCT/EP2017/074821

§ 371 Date: Mar. 30, 2020

(51) Int. Cl. B29C 64/112; B29C 64/291; B33Y 10/00; B33Y 70/00

(52) U.S. Cl. CPC B29C 64/112; B29C 64/291; B29K 2083/005; B33Y 70/00; B33Y 10/00

(57) ABSTRACT

Silicone elastomer-containing 3D articles are printed by a drop on demand technique using at least one first crosslinkable silicone as a structure forming material and at least one further structure forming material which is preferably a crosslinkable silicone different from the first crosslinkable silicone.

### CROSS REFERENCE TO RELATED APPLICATIONS

This application is the U.S. National Phase of PCT Appln. No. PCT/EP2017/074821, filed Sep. 29, 2017, the disclosure of which is incorporated in its entirety by reference herein.

### BACKGROUND OF THE INVENTION

### 1. Field of the Invention

The invention relates to a method for the additive manufacture of an object using a 3D printing device. The method is characterized in that printing compounds employed comprise (A) a structure-forming printing material consisting of a first crosslinkable silicone rubber composition and (B) one or more further structure-forming printing materials. Dropwise application of the printing compounds allows the fabrication of complex models from various materials, with a custom-tailored profile of properties. The invention also relates to objects manufactured by the aforesaid method.

### 2. Description of the Related Art

3D printing sees three-dimensional objects constructed layer by layer. Construction takes place under computer control from one or more liquid or solid materials according to specified geometries from CAD (Computer Aided Design). Construction is accompanied by physical or chemical processes of curing or solidification. Typical engineering materials for 3D printing are plastics, synthetic resins, ceramics, and metals. 3D printers are in use in industry, in research, and in the consumer segment too. 3D printing is a generative fabrication method and is also referred to as additive manufacture.

The principal methods for 3D printing are selective laser melting and electron beam melting for metals, and selective laser sintering for polymers, ceramics and metals. For liquid photopolymerizable synthetic resins, use is made of stereolithography and digital light processing, and also of polyjet modeling. For thermoplastics there is also fused deposition modeling.

3D printers serve initially, primarily, for manufacturing prototypes and models, and also for manufacturing objects of which only small quantities are required. There is growing importance of individualized geometries in medicine and sport, but also among objects which simply cannot be manufactured by other methods. One example are objects having interior lattice structures.

An advantage of 3D printing over the injection molding method is the absence of the costly and inconvenient production of tooling and molds. Relative to all material-ablating methods such as cutting and turning, 3D printing has the advantage that there is no need for machining of the original shape and there is virtually no loss of material.

Only a few 3D printing methods are known that allow printing of more than one material. For true elastomers, which include silicone elastomers, printing with a plurality of materials is hitherto unknown. By true elastomers are meant covalently crosslinked elastomers. Other elastomers, which are crosslinked not covalently but only via intermolecular forces, and which are therefore meltable and easier to work, are referred to as thermoplastic elastomers or thermoelastics.

U.S. Pat. No. 9,031,680 B2 describes the manufacture of objects from multiple materials by 3D printing. As a printing process, multijet printing is described. Materials used are acrylate-functional organic polymers, which are polymerized by UV light. They have a low viscosity and are therefore also called printing inks. While rubberlike materials are indeed described by U.S. Pat. No. 9,031,680 B2, they nevertheless differ from proper elastomers in having low elongation at break: a figure of 140% is quoted for a Shore A 40 material.

The desire is for a way to manufacture proper elastomers, i.e., rubber materials. Photopolymerizable acrylates or thermoplastic elastomers are not suitable for such manufacture. Silicones cannot be employed for the method disclosed in U.S. Pat. No. 9,031,680 B2, since their high viscosity and low surface tension mean they cannot be adapted to the given operational window.

Silicones are the only true elastomers for which there are 3D printing methods known.

US 2016/0263827 A1 describes a method wherein local crosslinking occurs when a crosslinking catalyst is added to a bath of liquid silicone through a metering needle which can be moved in three-dimensional space. The crosslinked component is subsequently removed mechanically from the bath and processed. This method is confined to soft silicones with a Shore A of less than 50, and does not permit construction from multiple materials.

WO 2017/040874 A1 describes a method wherein silicone is extruded from a nozzle which can be moved in three-dimensional space. The silicone may be thermally crosslinked in this extrusion. For the extrusion, which the skilled person also dubs “dispensing”, a silicone material is pressed through a nozzle needle, forming a strand as it is pressed, and is laid down on the building platform or surface already printed. The force needed to meter the silicone material can be generated by various means, such as a pump, a piston, gas pressure, for example, or a combination thereof. Typical nozzle diameters are 0.05 to 1 mm. Typical layer heights are 0.05 to 1 mm. The flow of material is withheld on reaching a position in which no material is to be printed and metered, until a position is reached in which the material is to be metered again. This method is described for the use of only one silicone material, and is also suitable only for simple geometries. Given the unavoidable stringing that occurs with silicone on cessation of the metering of the material, it is impossible in this way to fabricate components from more than one silicone material in the required resolution and geometrical accuracy.

A method for the 3D printing of silicones by the “drop-on-demand” process is described by WO 2016/071241 A1. With drop-on-demand printing, the pasty silicone material is ejected in the form of droplets from a metering valve. The typical nozzle diameter is 0.05 to 1 mm. The mode of operation of the valve is such that the material flows into the valve through a pressure, where it is expelled through a nozzle by means of a spring, a magnetic mechanism or a piezoelectric actuator similar to a piston pump. Typical droplet sizes with silicone material are 0.05 to 0.5 mm. Metering is interrupted if the metering apparatus is moved in a printing phase in which no material is to be printed. The droplet frequency is typically 100 to 1000 Hz; up to 10,000 Hz is possible with specific valves. This method has, however, been known to date only for the printing of a silicone material and possibly support material.

It was an object of the present invention to provide a method which permits the printing of elastomeric objects from various materials in one printing operation and which therefore provides access to objects having custom-tailored properties.

### SUMMARY OF THE INVENTION

It has been surprisingly found that droplets of crosslinkable silicone rubber compositions can be joined homogeneously to one another and to other materials, even if they have different properties and compositions. As a result it becomes possible to print objects from different materials. Each such material may be placed at any desired position in three-dimensional space as an individual droplet, independently of any other material. Sharp borders between the materials can be achieved, as can also fluid transitions, known as gradients. This gives rise to great freedom in the construction of components from different materials in one manufacturing step. Thus, the invention is directed to a layer by layer additive manufacturing process where drops of two or more structure forming materials are used, at least one of these being a crosslinkable silicone elastomer.

### BRIEF DESCRIPTION OF THE DRAWINGS

FIG. 1 illustrates a printing device for printing one material.

FIG. 2 illustrates a printing device for printing three different materials.

FIG. 3 illustrates a printed object with multiple segments, each consisting of one material.

FIG. 4 illustrates a printed object with multiple layers, each consisting of a materials mixture.

FIG. 5 illustrates a printed test object consisting of silicones of different color.

FIG. 6 illustrates a printed test object consisting of silicones of different hardnesses.

### DETAILED DESCRIPTION OF THE PREFERRED EMBODIMENTS

With the method of the invention it is possible to produce objects consisting of silicones with different color, hardness or chemical functionality. Combination with other materials which can be printed by this method is also possible—for example, acrylates, polyurethanes or epoxides. These objects therefore have different colors or color profiles, different hardnesses or hardness gradients, or composite structures of materials with different chemical composition. Of particular interest in this context are composite structures of hard and soft materials. Materials with different functionalities are also of interest, such as electrically conducting and nonconducting or hydrophilic and hydrophobic segments in one object, for example.

The invention thus relates to a method for the additive manufacture of an object using a 3D printing device, wherein the method comprises the following steps:

(1) layer-by-layer application of two or more printing compounds in the form of drops to a platform, to a secondary component positioned thereon, or to a printing compound layer applied beforehand, wherein the printing compounds comprise the following materials:
(A) a structure-forming printing material consisting of a first crosslinkable silicone rubber composition, and
(B) one or more additional structure-forming printing materials;

(2) Full or partial crosslinking of the applied printing compounds;

(3) Repetition of steps (1) and (2) until construction of the object is complete.

Suitable 3D printing devices are known in the prior art and are described for example in WO 2016/071241 A1. The 3D printing device preferably comprises at least one delivery device, a source of electromagnetic radiation, and a platform.

The delivery device is preferably set up such that it is able to deliver printing compounds in the form of individual isolated drops (voxels). To deliver individual drops, the delivery device may comprise, for each printing compound, a nozzle which emits liquid drops of printing compound in the direction of the platform. Such nozzles are also called jetting nozzles.

The delivery device preferably comprises jet valves with piezoelectric elements. They enable the delivery both of low-viscosity materials, where drop volumes for drops of a few picoliters (pL) (2 pL correspond to a drop diameter of around 0.035 μm) can be realized, and of medium- and high-viscosity materials such as, in particular, silicone rubber compounds, where piezoelectric printheads with a nozzle diameter of between 50 and 500 μm are preferred and drop volumes in the nanoliter range (1 to 100 nL) can be produced. With low-viscosity compounds (less than 100 mPa·s), these printheads are able to deliver droplets with a very high metering frequency (around 1 to 30 kHz), whereas with higher-viscosity compounds (above 100 Pa·s) it is possible to achieve metering frequencies of up to around 500 Hz, depending on the rheological properties (shear-thinning behavior). Suitable jetting nozzles are known in the prior art and are described for example in DE 102011108799 A1.

The printing compounds are applied preferably by means of Drop-on-Demand (DOD methods) In the Drop-on-Demand method, each printed drop is generated beforehand in a targeted way and is laid down at a location defined for that drop.

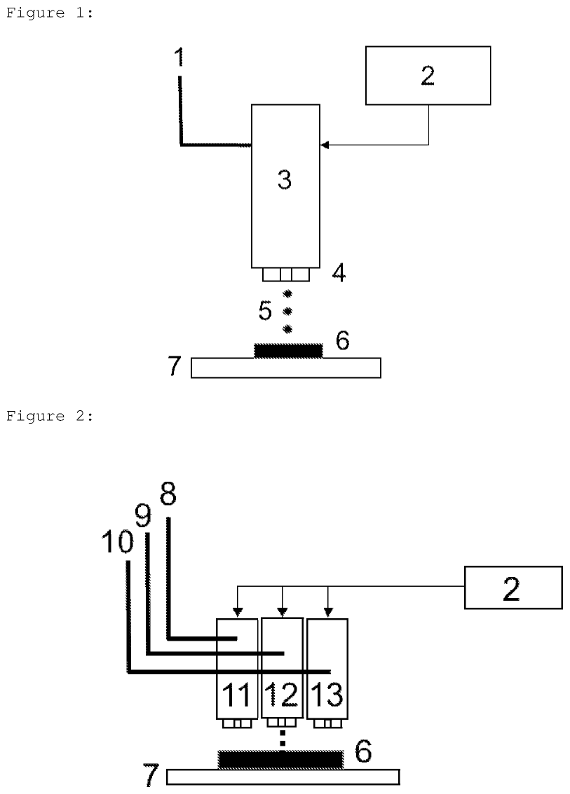

FIG. 1 shows the schematic construction of a printing device for printing a printing material. The feed line 1 conveys printing compound into the valve 3, which through corresponding functioning meters the printing material in the form of individual droplets from the nozzle 4. The droplets land on the platform 7 or on layers already printed beforehand, and shape the object 6. The object 6 is complete when all the layers have been printed. The functions of the valve are controlled by a computer 2. In the printing device the valve can be placed by corresponding movement units at any site in the three-dimensional space. After the metering of the individual drops, the material is still chemically noncrosslinked, and is crosslinked after formation of one layer or in accordance with another crosslinking strategy. In the case of thermally-crosslinkable materials, this may be accomplished by supply of heat—for example, through irradiation with infrared light.

With photocrosslinkable materials, it may be accomplished by exposure to light—for example, with a UV light source. Crosslinking may of course also take place after parts of a layer have been printed or after a plurality of layers have been printed.

FIG. 2 shows the schematic construction of a printing device for printing multiple printing materials. The printing device consists of a plurality of valves each for one material. In principle it would also be possible to meter multiple materials through one valve. To do so, however, is impractical because of the long rinsing times required and high losses of material. The various materials are metered through the respective valves, with each valve having a dedicated material supply facility. FIG. 3 by way of example shows three materials 8, 9 and 10 and the associated valves 11, 12 and 13. Any desired number of materials and valves may be employed, however. The limit is imposed ultimately by the size of the printing device. In principle, therefore, a very large number of valves may also be arranged. The printing device may be controlled via a computer 2. The materials are placed onto the platform 7, onto a secondary component positioned thereon or onto layers already printed beforehand, and form the object 6 when all the layers have been printed.

The printing compounds of the present invention comprise at least one structure-forming printing material consisting of a first crosslinkable silicone rubber composition. A structure-forming printing material in the context of the present invention refers to a printing material which is used to construct the structure of the object itself. In comparison to this, various support materials may also be used, but are removed again following construction of the object.

Besides the first crosslinkable silicone rubber composition, the printing compounds of the present invention comprise one or more additional structure-forming printing materials.

In one particular embodiment, the printing compounds comprise the following materials:
(A) a structure-forming printing material consisting of a first crosslinkable silicone rubber composition, and
(B1) a structure-forming printing material consisting of a second crosslinkable silicone rubber composition, which differs from the first crosslinkable silicone rubber composition, and

optionally (B2) one or more additional structure-forming printing materials.

Suitable silicone rubber compositions are disclosed in the prior art. Particularly suitable silicone rubber compositions are those described in WO 2017/081028 A1, WO 2017/089496 A1, and WO 2017/121733 A1.

The crosslinkable silicone rubber composition and/or any additional silicone rubber compositions in the noncrosslinked state preferably has a viscosity of 10 Pa·s or more, preferably 40 Pa·s or more, more preferably 100 Pa·s or more, yet more preferably 200 Pa·s or more, and 1,000 Pa·s or less, measured in each case at 25° C. and a shear rate of 0.5 s⁻¹.

The viscosity of the silicone rubber composition may be measured with a rheometer in accordance with DIN EN ISO 3219: 1994 and DIN 53019, in which case use may be made of a cone-plate system (CP50-2 cone) having an opening angle of 2°. A suitable rheometer is, for example, the “MCR 302” from Anton Paar; Graz, Austria. The instrument may be calibrated with a standard material, as for example standard oil 10000 from the Physikalisch-Technischen Bundesanstalt, Braunschweig, Germany.

The silicone rubber compositions may be formulated with one or more components, preferably one component.

The silicone rubber compositions used in the method of the invention are preferably addition-crosslinking silicone rubber compositions. Addition-crosslinking silicone rubber compositions are crosslinked typically by reaction of unsaturated groups, as for example alkenyl groups, with Si—H groups (hydrosilylation) in the silicone rubber composition. The crosslinking may be induced either thermally and/or by UV or UV-VIS light. Silicone rubber compounds of these kinds are known from, for example, WO 2016/071241 A1 and the publications cited therein.

The crosslinking comes about preferably by UV/VIS-induced activation of a photosensitive hydrosilylation catalyst, with platinum complexes being preferred catalysts. The prior art discloses numerous photosensitive platinum catalysts which are largely inactive in the absence of light and can be converted by irradiation with UV/VIS light into platinum catalysts which are active at room temperature.

As already mentioned above, the printing compounds according to the present invention additionally comprise one or more additional structure-forming printing materials. In this context the following materials are particularly preferred: silicone gels, silicone resins, homopolymers or copolymers of monomers selected from the group consisting of acrylates, olefins, epoxides, isocyanates or nitriles, and also polymer mixtures comprising one or more of the aforesaid polymers. Consideration is given, for example, to polymers and copolymers of butadiene, acrylates, acrylonitrile, butyl, chloroprene, fluoro rubber, isoprene, natural rubber, styrene, vinyl chloride, polyvinyl butyral or olefins. The printing compounds are preferably materials which at least during processing are present in a flowable form and which after discharge can be cured or crosslinked.

All printing compounds may be formulated with one or more components, preferably one component.

The structure-forming materials, preferably the first and second silicone rubber compositions, optionally further silicone rubber compositions, may in the crosslinked state differ in respect, for example, of the Shore hardness, the electrical conductivity, the thermal conductivity, the color, the transparency, the hydrophilicity and/or the swelling behavior.

The structure-forming printing compounds preferably comprise the above-described silicone rubber compositions in an amount of 50 wt % or more, more preferably 70 wt % or more, and most preferably 90 wt % or more, based in each case on the total weight of the structure-forming printing compounds. In one particularly preferred embodiment, the structure-forming printing compounds consist exclusively of one or more silicone rubber compositions.

In one preferred embodiment the printing compounds additionally comprise one or more support materials, which are removed again on conclusion of construction of the object.

The setting of support material may be necessary if the object is to have cavities, undercuts, overhanging, self-supporting or thin-walled parts, since the printing compounds cannot be put in free suspension in space. During the printing operation, the support material films space volumes and serves as a base or as a scaffold in order for the printing compounds to be able to be placed thereon and cured. After the end of the printing operation, the support material is removed again, to give the cavities, undercuts and also overhanging, self-supporting or thin-walled portions of the printed object. In addition, support material may also be provided at locations at which in technical terms it is not absolutely necessary. Accordingly, components may be packed, for example, into support material in order to increase the quality of the printed outcome or to influence the surface quality of the printed product.

Generally, speaking, the support material used is a material which differs from the materials of which the object is printed—for example, it is a noncrosslinking and noncohesive material. The necessary shape of the support material is calculated depending on the geometry of the object. During the calculation of the shape of the support material, various strategies may be employed in order, for example, to use as little support material as possible or to increase the dimensional integrity of the product.

If support material is employed, then the printhead may have one or more further delivery devices for the support material,

or one or more further nozzles. Alternatively or additionally, a further printhead with corresponding delivery devices may also be provided for the delivery of support material. Suitable support materials are known in the prior art. Particular suitability is possessed by the supportive materials as described in WO 2017/020971 A1.

The drops of the individual printing compounds are preferably applied such as to form within the object one or more segments each consisting of only one structure-forming printing material or support material.

FIG. 3 shows an object printed by way of example, which has been printed from three different materials 14, 15 and 16, the object consisting of three segments each of which consists of one material and the entirety of which forms the volume of the object. In this case the boundaries between the different materials are sharply defined.

In a further preferred embodiment, the drops of the individual printing compounds are applied such as to form within the object one or more segments each consisting of a mixture of two or more structure-forming printing materials, the mixing ratio of the structure-forming printing materials in each segment being constant.

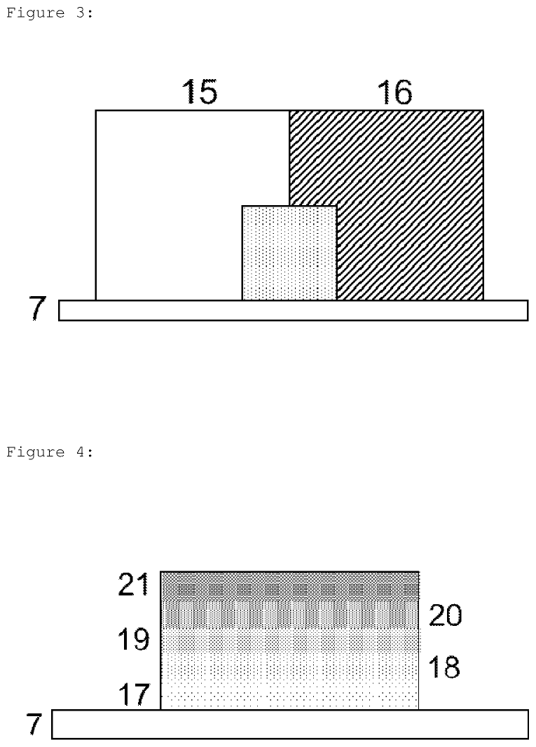

FIG. 4 shows an object printed by way of example, which is constructed of five different layers 17, 18, 19, 20 and 21. In this case each layer has been composed of two different materials by means of corresponding placement of individual droplets. The layers may consist of one stratum of individual droplets and be 0.05 to 1.0 mm thick, or else may consist of a plurality of strata. For example, layer 17 contains 5% of material 1 and 95% of material 2, layer 18 contains 10% of material 1 and 90% of material 2, layer 19 contains 20% of material 1 and 80% of material 2, layer 20 contains 25% of material 1 and 75% of material 2, and the last layer 21, contains 30% of material 1 and 70% of material 2. Accordingly there is a fluid transition from material 1 to material 2 from the first to the last layer.

FIGS. 3 and 4 describe the construction only in principle. Any desired gradients may be produced with a different number of layers, segments and materials. The arrangement of these gradients in space is arbitrary.

In a further preferred embodiment, the drops of the individual printing compounds are applied sso as to form within the object, one or more segments each consisting of a mixture of two or more structure-forming printing materials, the mixing ratio of the structure-forming printing materials in each segment being subject to a gradient.

The drops of the individual structure-forming printing compounds may be placed at any desired location in the three-dimensional space, and are joined to one another homogeneously after placement. The homogenous joining of the drops with one another means that, in one printing operation, objects can be manufactured that consist of different materials and materials mixtures.

In the method of the invention there is full or partial crosslinking of the applied printing compound. This is preferably achieved by electromagnetic radiation. The electromagnetic radiation acts on the printing compounds preferably site-selectively or extensively, in pulsed form or continuously, and with constant or variable intensity.

It may be judicious to subject the entire working area during printing to permanent irradiation, in order to achieve complete crosslinking, or to expose it to the radiation only for short duration(s), in order to bring about incomplete crosslinking (partial crosslinking/green strength) in a deliberate way—this may in certain circumstances be accompanied by improved adhesion of the individual layers to one another.

The full or partial crosslinking of the printing compounds is preferably accomplished thermally and/or by UV or UV/VIS radiation, most preferably by UV or UV/VIS radiation.

UV radiation has a wavelength in the range from 100 nm to 380 nm, whereas visible light (VIS radiation) has a wavelength in the range from 380 to 780 nm.

UV/VIS-induced crosslinking has advantages over thermal crosslinking. One is that intensity, exposure time, and exposure site of the UV/VIS radiation can be precisely calculated, while the heating of the applied structure-forming printing materials (and their subsequent cooling as well) always takes place with a delay, owing to a relatively low thermal conductivity. Because of the intrinsically very high coefficient of thermal expansion of the silicone rubber compositions, the temperature gradients that are inevitable on thermal crosslinking lead to mechanical stresses which may adversely affect the dimensional integrity of the object formed, and in extreme cases may cause unacceptable distortions of shape.

The rate of the UV/VIS-induced crosslinking is dependent on numerous factors, especially on the type and concentration of the photosensitive catalyst, on the intensity, wavelength and exposure time of the UV/VIS radiation, the transparency, reflectivity, layer thickness and composition of the printing compound, and the temperature.

Light used for curing the silicone rubber compounds which crosslink under UV/VIS-induction preferably has a wavelength of 240 to 500 nm, more preferably 250 to 400 nm, yet more preferably 350 to 400 nm, and especially preferably 365 nm.

To achieve rapid crosslinking, which means a crosslinking time at room temperature of less than 20 min, preferably less than 10 min, more preferably less than 1 min, it is advisable to use a UV/VIS radiation source having an output of between 10 mW/cm² and 20,000 mW/cm², preferably between 30 mW/cm² and 15,000 mW/cm², and also a radiation dose of between 150 mJ/cm² and 20,000 mJ/cm², preferably between 500 mJ/cm² and 10,000 mJ/cm². Within these values for output and dose it is possible to realize area-specific irradiation times of between 2,000 s/cm² at a maximum and 8 ms/cm² at minimum.

Where printing compounds are used which cure under UV/VIS exposure, the 3D printing device preferably has a UV/VIS exposure unit. In the case of site-selective exposure, the UV/VIS source is arranged movably relative to the platform and illuminates only selective regions of the object. In the case of extensive exposure, the UV/VIS source in one variant is configured such that the entire object or an entire material layer of the object is exposed at once. In one preferred variant the UV/VIS source is so designed that its luminous intensity or its energy can be varied and that the UV/VIS source exposes only a subregion of the object at the same time, in which case the UV/VIS source may be moved relative to the object in such a way as to allow the entire object to be exposed to the UV/VIS light, possibly with varying intensity. For this purpose, for example, the UV/VIS source is configured as a UV/VIS LED strip and is moved relative to the object and/or over the printed object.

In the case of thermally-crosslinkable printing compounds, the crosslinking may be accomplished by IR radiation, as for example by means of an (N) IR laser or an infrared lamp.

Curing is implemented using a curing strategy. The printing compounds are preferably cured after the placement of one layer, after the placement of two or more layers, or directly during printing.

Curing of the printing compounds directly during printing is referred to as the direct curing strategy. Where, for example, structure-forming printing materials are used that are curable by UV/VIS radiation, then in comparison to other curing strategies the UV/VIS source is active for a very long time, allowing operation to take place with a very much lower intensity, so leading to slow crosslinking through the volume of the object. This limits the heating of the object and leads to objects of dimensional integrity, since there is no expansion of the object resulting from temperature spikes.

In the case of the per-layer curing strategy, the layer of material placed is crosslinked under radiation induction after each complete layer of material has been placed. During this procedure, the freshly printed layer joins to the cured printed layer beneath it. Curing does not take place immediately after the placement of a printing compound, and so the printing compounds have time to relax prior to curing. This means that the printing compounds are able to merge, so achieving a smoother surface than in the case of the direct curing strategy.

The procedure in the case of the n-layer curing strategy is similar to that of the per-layer curing strategy, but curing is performed only after n layers of material have been placed, with n being a natural number. The time available for the printing compounds to relax is increased further, so further improving the surface quality.

After curing, the printed object may be aftertreated or post-machined. The aftertreatment is selected preferably from one or more of the following techniques: heat treatment, surface coating, placement of incisions, dividing and separation of segments, and assembly of individual components. The component may be heat-treated, for example, at 200° C. for 4 hours. This corresponds to a typical thermal conditioning treatment for silicone elastomers. A particularly suitable thermal conditioning treatment is described in WO 2010/015547 A1.

Furthermore, the models after 3D printing may be coated locally or wholly, so as to optimize the surface properties of the model, for example. The properties which may be optimized by coating include, for example, surface roughness, coefficient of friction, color, component transparency, reduction in the step effect of 3D printing, application of a surface layer differing in materials terms from the component itself, etc. A further possibility of post-machining is, for example, the placement of cuts, dividing and/or removal of individual segments, or the assembly of individual components.

The present invention further relates to an object manufactured by the 3D printing method described above. This object may also be manufactured through a combination of a 3D printing method of this kind with at least one other additive or conventional fabrication technology.

The object printed in accordance with the invention comprises a silicone elastomer and one or more other materials, the silicone elastomer and the other materials being joined to one another homogeneously. In one preferred embodiment, the object printed in accordance with the invention consists of a silicone elastomer, one or more other materials, and optionally a secondary component, and the silicone elastomer, the other materials and the secondary component are joined to one another homogeneously.

The object printed in accordance with the invention preferably comprises two or more silicone elastomers, which are joined to one another homogeneously. In one preferred embodiment, the object printed in accordance with the invention consists of two or more silicone elastomers, optionally other materials, and optionally a secondary component, and the silicone elastomers, the other materials and the secondary component are joined to one another homogeneously.

The object preferably consists, to an extent of 50 wt % or more, more preferably 70 wt % or more, and most preferably 90 wt % or more, of one or more silicone elastomers, based in each case on the total weight of the object. In one particularly preferred embodiment, the object consists exclusively of one or more silicone elastomers.

In one preferred embodiment of the invention, the object is manufactured on the basis of a digital 3D model. The digital model may be produced by construction using corresponding CAD (Computer Aided Design) software. Also serving as a starting point may be geometries from medical imaging methods, such as computer tomography or nuclear magnetic resonance tomography, for example. Through corresponding segmentation, objects are imported into the CAD software and processed further therein. Scanning can also be used to generate digital objects and import them into the CAD software. The file format selected may be such that through further data processing a new file format can be generated from it, from which the machine control for the printing device receives the necessary information on performing the 3D printing.

The format generated from the digital object is typically an STL format (STL=Standard Tessellation Language). Numerous CAD systems include this interface or a separate software package is used for it. A description of the interface between construction and STL file format is found in Chua Chee Kai, Gan G. K. Jacob and Tong Mei, Interface between CAD and Rapid Prototyping systems, The International Journal of Advanced Manufacturing Technology, August 1997, Volume 13, Issue 8, pp 571-576.

There are other file formats from which the software for controlling the printing device can take information concerning the nature of the object to be manufactured. In the present description of the invention, the STL file format is chosen to represent other file formats. This is not intended to represent any restriction; the method of the invention can also be performed with other file formats.

If segments with different materials are intended in the construction for the object to be manufactured, then there are various solutions for compiling a digital model which is to be printed from different materials.

The object may, for example, be divided into segments for respectively different materials, in which case there is an independent STL file for each segment, and the mathematical overlaying of the individual segments produces the object in its entire volume. The printing device software “slices” the object into individual layers and in so doing receives for each layer the information as to the position at which the respective material is to be placed. Alternatively, the object in its entire volume is present as an STL file, and the printing device software applies certain algorithms whereby different materials are placed at defined positions in each layer.

In the method of the invention, the digital 3D model is preferably divided into segments for a respective printing compound and is produced by placing the individual segments one above another.

In a further embodiment of the method of the invention, the digital 3D model preferably represents the entire object, and the individual printing compounds are printed via software algorithms.

The printing device software typically compiles instructions for controlling the printing device, and the printing device prints one layer after the other in accordance with these instructions, placing different materials at the positions intended for them.

The digital 3D model may be digitally reprocessed before the object is printed. The digital object may be reprocessed on a volume, network and/or point basis. The digital models may be reprocessed with utilization of different programs and software environments, ranging from conventional engineering tools such as CAD programs through intuitive manual design environments.

First of all, the network of the surface models for further processing is examined for errors, cleaned up and, if necessary, smoothed. In order to be able to manage the data quantity of the models, network simplification through a reduction in the triangle surfaces is also aimed at. The stated steps for network management become due, in iterative loops, after further model processing steps as well.

### EXAMPLES

The examples which follow were produced using a 3D printer (ACEO® Imagine Series 100, Wacker Chemie A G) which is set up for printing objects by the DOD method. The printer is equipped with software (ACEO® Studio Software, Wacker Chemie A G) which is able to import STL file formats for the objects to be manufactured. The construction and the mode of operation of the printer are described in WO 2016/071241 A1. For the examples, the printer was equipped with three different valves. Three different silicone compositions, produced according to WO 2017/089496 A1, and a support material, produced according to WO 2017/020971 A1, were used. The printer was set to a layer height of 0.4 mm and it printed with a frequency of 200 Hz.

### Example 1

The test object was an ACEO® logo consisting of a colorless 50×15×2 mm baseplate, to which a 3.2 mm high text “ACEO” was applied by printing, with letters 10 mm in size.

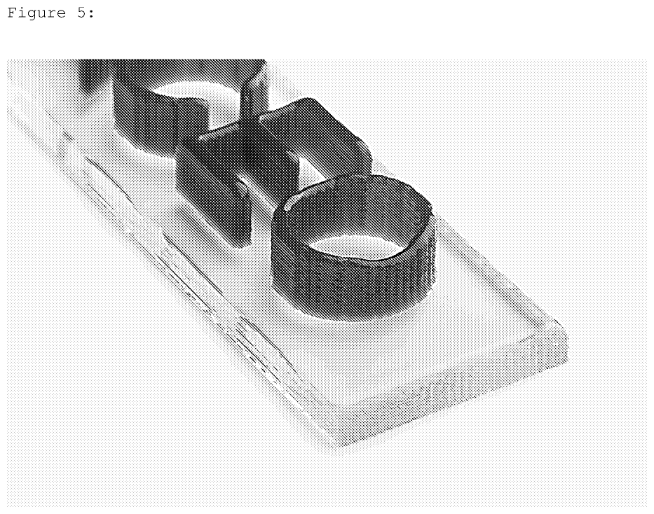

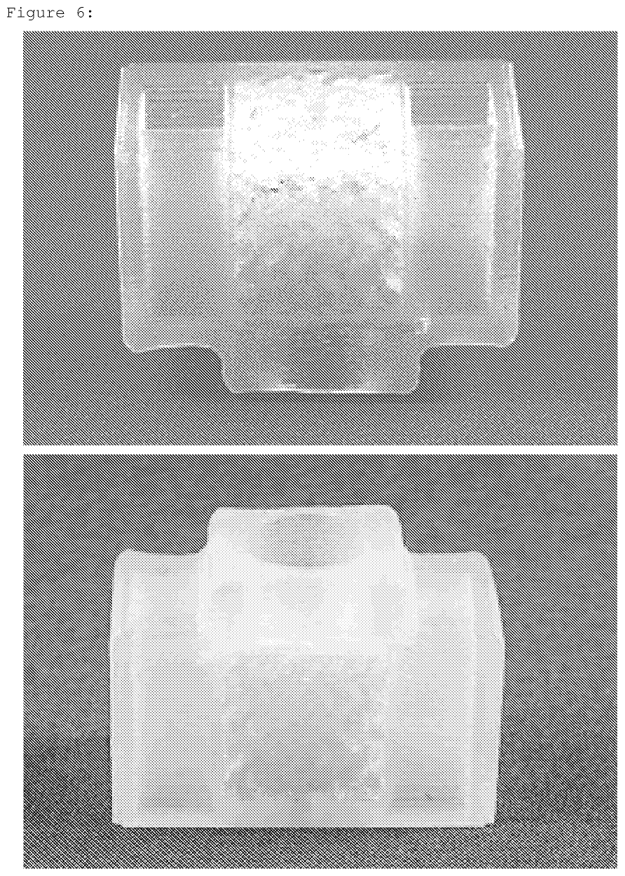

Valve 1 first printed five layers of a transparent silicone 1. After each layer, the silicone 1 was crosslinked with UV light. The printer control then switched to valve 2 and printed the text “ACEO” in eight layers from a dark green silicone 2. Here again, crosslinking with UV light took place after each layer. FIG. 5 shows this test object from example 1. The object therefore consisted of two different silicones, printed one after the other in one printing operation, which were joined to one another homogeneously.

### Example 2

The procedure was performed in the same way as for example 1.

The test object was an object with integrated function. The external dimensions were 35×15×25 mm. The object consisted of a housing segment, an internal segment with a lattice structure, and a flap valve toward the upper opening. The internal lattice structure formed a spring against the flap valve. The object acted as a unidirectional valve.

The outer housing of silicone with a Shore A hardness of 60 was printed from valve 1. Valve 2 printed an internal lattice structure of silicone with a Shore A hardness of 40 and valve 3 printed the support material needed for the lattice structure. After printing, the support material was removed by washing with water. FIG. 6 shows the test object from example 2 from two perspectives. The object consisted of segments of different silicones, printed simultaneously in one printing operation, which were joined to one another homogeneously.

Through the examples it was possible to show that with the method of the invention it is possible to generate objects made of different materials in one printing operation. Individual drops of materials can be placed at any desired location in the three-dimensional space. These drops are joined to one another homogeneously.

### REFERENCE NUMERALS IN THE FIGURES

1 Material supply line

2 Computer for control

3 Valve

4 Nozzle

5 Drops of material

6 Object

7 Platform

8 Supply line, first material

9 Supply line, second material

10 Supply line, third material

11 Valve for first material

12 Valve for second material

13 Valve for third material

14 Segment of first material

15 Segment of second material

16 Segment of third material

17 First layer of material

18 Second layer of material

19 Third layer of material

20 Fourth layer of material

21 Fifth layer of material

1.-16. (canceled)

17. A method for the additive manufacture of an object from various materials comprising a silicone elastomer and one or more further materials using a 3D printing device, the method comprising the following steps:
(1) layer-by-layer application of two or more different printing compounds in the form of drops by means of a drop-on-demand method to a platform, to a secondary component positioned thereon, or to a printing compound layer applied beforehand, wherein the following materials are used as printing compounds:
(A) a structure-forming printing material consisting of a first crosslinkable silicone rubber composition,
wherein the first crosslinkable silicone rubber composition has a viscosity of 10 Pa·s or more, measured at 25° C. and a shear rate of 0.5 s⁻¹, and
(B) one or more additional structure-forming priming materials;
(2) fully or partially crosslinking the applied printing compounds;
(3) repeating steps (1) and (2) until construction of the object is complete.

18. The method of claim 15, wherein the structure-forming printing materials (B) additionally comprise one or more of the following materials:
silicone gels, silicone resins, and/or homopolymers or copolymers of monomers of acrylates, olefins, epoxides, isocyanates, nitriles or mixtures thereof, and also polymer mixtures comprising one or more of the aforesaid polymers.

19. The method of claim 15, wherein the following materials are used as printing compounds:
(A) a structure-forming printing material consisting of a first crosslinkable silicone rubber composition, and
(B1) a structure-forming printing material. consisting of a second crosslinkable silicone rubber composition, which differs from the first crosslinkable silicone rubber composition, and
optionally (B2) one or more additional structure-forming printing materials.

20. The method of claim 17, wherein the first and/or second crosslinkable silicone rubber composition has a viscosity of 10 Pa·s or more, measured at 25° C. and a shear rate of 0.5 s⁻¹.

21. The method of claim 17, wherein the first and/or second crosslinkable silicone rubber composition has a viscosity of 40 Pa·s or more, measured at 25° C. and a shear rate of 0.5 s⁻¹.

22. The method of claim 17, wherein the first and/or second crosslinkable silicone rubber composition has a viscosity of 100 Pa·s or more, measured at 25° C. and a shear rate of 0.5 s⁻¹.

23. The method of claim 17, wherein the first and/or second crosslinkable silicone rubber composition has a viscosity of 200 Pa·s or more, measured at 25° C. and a shear rate of 0.5 s⁻¹.

24. The method of claim 17, wherein the full or partial crosslinking is induced (a) thermally and/or (b) by UV or UV-VIS light.

25. The method of claim 17, wherein the following materials are additionally used as printing compounds:
(C) one or more supporting materials, which are removable again on conclusion of construction of the object.

26. The method of claim 17, wherein the drops of the individual printing compounds are applied so as to form within the object one or more segments each consisting of only one structure-forming printing, material or support material.

27. The method of claim 17, wherein the drops of the individual printing compounds are applied so as to form within the object one or more segments each consisting of a mixture of two or more structure-forming printing materials, the mixing ratio of the structure-forming printing materials in each segment being constant.

28. The method of claim 15, wherein the drops of the individual printing compounds are applied so as to form within the object one or more segments each consisting of a mixture of two or more structure-forming printing materials, the mixing ratio of the structure-forming printing materials in each segment being subject to a gradient.

29. The method of claim 17, wherein the object after printing is aftertreated or post-machined.

30. The method of claim 17, wherein the aftertreatment comprises from one or more of the following techniques: heat treatment, surface coating, placement of incisions, division and removal of segments, and assembly of individual components.

31. The method of claim 17, wherein the object is manufactured on the basis of a digital 3D model of the object.

32. The method of claim 31, wherein the digital 3D model is divided into segments for a respective printing compound, and the digital 3D model is produced by placing the individual segments one above another.

33. The method of claim 31, wherein the digital 3D model represents the entire object and the individual printing compounds are printed via software algorithms.
